(19) United States
(12) Patent Application Publication
(10) Pub. No.: US 2006/0012819 A1
(43) Pub. Date: Jan. 19, 2006

(54) Imaging device power management system and method

(76) Inventors: William R. Haas, Fort Collins, CO (US); Kirk S. Tecu, Greeley, CO (US); David W. Boll, Greeley, CO (US)

Correspondence Address: HEWLETT-PACKARD COMPANY;Intellectual Property Administration, P.O. Box 272400, Fort Collins, CO, 80527-2400, US

(21) Appl. No.: 10/889,696

(22) Filed: Jul. 13, 2004

(51) Int. Cl. G06K 15/00

(52) U.S. Cl. 358/1.14

(57) ABSTRACT

An imaging device power management system comprises a control circuit adapted to adapted to vary a duty cycle of a scanning module of an imaging device during a scanning operation performed by the scanning module based on a source of energy coupled to the imaging device for operating the scanning module.

### BACKGROUND

Imaging devices are generally powered by a conventional alternating current (AC) external power source (i.e., 100-120 volts or, for some countries, 200-240 volts). Recently, a data interface bus (e.g., a universal serial bus (USB)) has become a widely used medium for providing power to various types of imaging devices, thereby enabling the device to obtain power from another electronic device (e.g., a desktop or notebook computer) and alleviating a need for a separate conventional AC power source or outlet. However, because of the generally low power level available via a data interface bus (e.g., approximately 2 watts), scanning operations performed by the imaging device using power supplied by a data interface bus are generally very slow.

### SUMMARY OF THE INVENTION

In accordance with one embodiment of the present invention, an imaging device power management system comprises a control circuit adapted to vary a duty cycle of a scanning module of an imaging device during a scanning operation performed by the scanning module based on a source of energy coupled to the imaging device for operating the scanning module.

In accordance with another embodiment of the present invention, an imaging device power management method comprises varying a duty cycle of a scanning module of an imaging device during a scanning operation performed by the scanning module based on the type of energy source coupled to the imaging device for performing the scanning operation.

In accordance with another embodiment of the present invention, an imaging device power management system comprises a light source adapted to illuminate an object during a scanning operation and a storage device adapted to store energy received from a data interface bus. The system also comprises a control circuit adapted to vary a duty cycle of the light source during the scanning operation corresponding to the energy stored in the storage device.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of an imaging device power management system in accordance with the present invention;

FIG. 2 is diagram illustrating an embodiment of a control circuit of the imaging device power management system of FIG. 1; and

FIG. 3 is a flow diagram illustrating an embodiment of an imaging device power management method in accordance with the present invention.

### DETAILED DESCRIPTION OF THE DRAWINGS

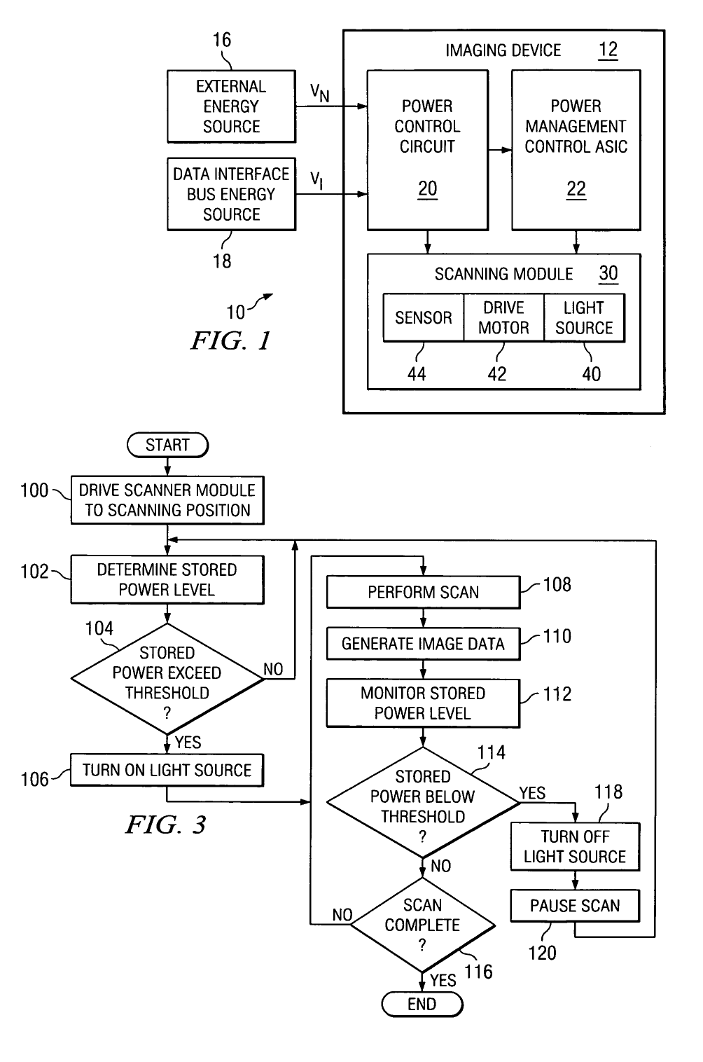

The preferred embodiments of the present invention and the advantages thereof are best understood by referring to FIGS. 1-3 of the drawings, like numerals being used for like and corresponding parts of the various drawings.

FIG. 1 is a diagram illustrating an embodiment of an imaging device power management system 10 in accordance with the present invention. In the embodiment illustrated in FIG. 1, system 10 comprises an imaging device 12 adapted to receive power or energy from any of a plurality of different types of energy sources. For example, in the embodiment illustrated in FIG. 1, imaging device 12 is configured to receive energy from an external energy source 16, represented as V_{W}, and a data interface bus energy source 18, represented as V_{I}. Data interface bus energy source 18 may comprise any type of bus or data communication medium for supplying power or energy to imaging device 12 such as, but not limited to, a universal serial bus (USB). External energy source 16 may comprise any type of energy source for providing energy or power to imaging device 12 such as, but not limited to, a conventional AC power supply (e.g., 100-120 volts or, in some countries, 200-240 volts). It should be understood that additional and/or other types of energy sources may also be used to provide power or energy to imaging device 12.

Imaging device 12 may comprise any type of device for capturing or otherwise generating a scanned image of an object such as, but not limited to, a scanner, facsimile machine, or copier. Briefly, system 10 enables operation of imaging device 12 using any one of a plurality of different types of energy sources and, depending on the type of energy source providing power for operating imaging device 12, imaging device 12 is configured to variably control a duty cycle of imaging device 12 components to efficiently manage power consumption by imaging device 12 and enable operation of imaging device 12 with a reduced scanning time based on the type of power supply providing power to scanning device 12 for the scanning operation.

In the embodiment illustrated in FIG. 1, imaging device 12 comprises a power control circuit 20 and a power management control application specific integrated circuit (ASIC) 22 for controlling the operation of a scanning module 30. In the embodiment illustrated in FIG. 1, scanning module 30 comprises a light source 40 for illuminating an object during a scanning operation, a drive motor 42 for either driving or moving scanning module 30 relative to an object during a scanning operation or moving the object relative to scanning module 30, and a photosensitive sensor 44 for capturing light reflected from the object and generating a scanned image of the object. However, it should be understood that scanning module 30 may comprise other components used during a scanning operation for generating a scanned image of an object.

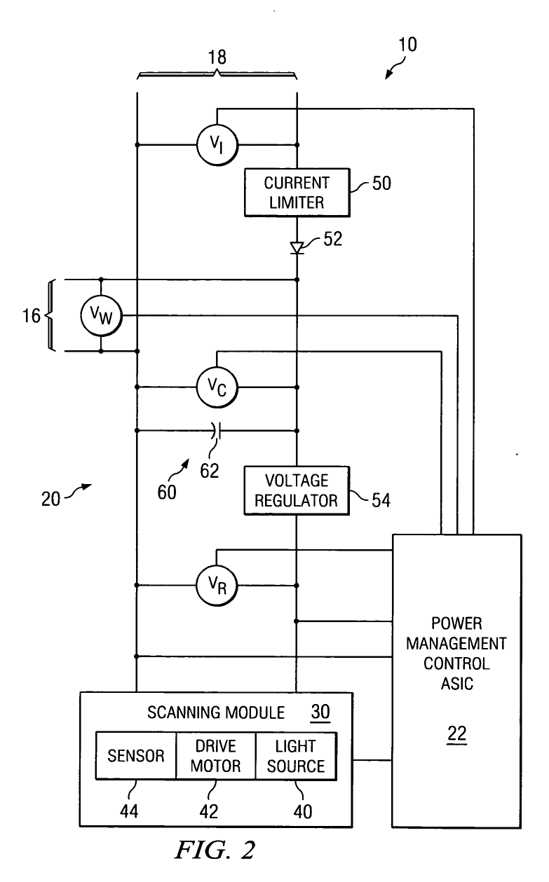

FIG. 2 is a diagram illustrating an embodiment of circuit 20 of system 10 in accordance with the present invention. In the embodiment illustrated in FIG. 2, circuit 20 comprises a current limiter 50 disposed between a diode 52 and an input for receiving power or energy, represented as V_{I}, from data interface bus energy source 18 for limiting or controlling an amount of energy or power drawn or otherwise received from data interface bus energy source 18. Energy or power received from external energy source 16 is represented in FIG. 2 as V_{W}. In operation, diode 52 prevents energy received from external energy source 16 from flowing through a port associated with data interface bus energy source 18. Circuit 20 also comprises a voltage regulator 54 disposed between diode 52 and scanning module 30 to regulate a voltage level supplied to scanning module 30. In the embodiment illustrated in FIG. 2, circuit 20 also comprises a storage device 60 for storing energy or power received from data interface bus energy source 18, represented as V_{C}. In the embodiment illustrated in FIG. 2, storage device 60 comprises a capacitor 62. As illustrated in FIG. 2, ASIC 22 is coupled to circuit 20 having inputs corresponding to V_{I}, V_{W}, V_{C}, and V_{R}, where V_{C} represents a voltage level stored by storage device 60, and V_{R} represents a voltage level necessary for operating scanning module 30. Measurement of voltage levels corresponding to locations of circuit 20 identified as V_{I}, V_{W}, V_{C}, and V_{R} may be obtained using any type of voltage measurement device.

In operation, ASIC 22 monitors voltage levels of circuit 20, such as V_{I}, V_{W}, V_{C}, and V_{R}, to determine and control a duty cycle for operating scanning module 30 during a scanning operation. For example, if inputs to ASIC 22 indicate that energy is being received by imaging device 12 by external energy source 16, for example, based on a voltage measurement of V_{W}, ASIC 22 is configured to operate scanning module 30 at a particular duty cycle, for example, a 100% duty cycle. However, if imaging device 12 is receiving a reduced level of power or energy, for example, from data interface bus energy source 18, ASIC 22 is configured to vary a duty cycle for operating scanning module 30 during a scanning operation. For example, in operation, when energy is received via data interface bus energy source 18, energy is stored by storage device 60 such that energy from storage device 60 is used to operate scanning module 30 during a scanning operation. If the energy level of storage device 60 is equal to or decreases to a value within a predetermined threshold or range of V_{R}, ASIC 22 pauses the scanning operation, for example, by turning off light source 40 and suspending movement of scanning module 30, to enable or otherwise facilitate recharging of storage device 60. In response to the energy level stored in storage device 60 increasing to a predetermined value or threshold, ASIC 22 resumes the scanning operation by turning on light source 40 and resuming movement of scanning module 30. Thus, for example, when V_{C} is equal to or greater than V_{R} plus a predetermined voltage measurement or threshold, ASIC 22 is configured to resume operation of scanning module 30. Additionally, as described above, if power or energy is available via external energy source 16, V_{C} will be greater than V_{R}, thereby enabling operation of scanning module 30 at a 100% duty cycle. Logic rules for operating scanning module 30 at a variable duty cycle may be expressed by the following: when V_{C}=V_{R} (or V_{R}+C), where C represents a predetermined or threshold voltage level, ASIC 22 is configured to turn off light source 40 and pause or suspend movement of scanning module 30; and when V_{C}=V_{I}+C, ASIC 22 is configured to turn on light source 40 and resume the scanning operation. Thus, ASIC 22 is configured to automatically vary a duty cycle of scanning module 30 (e.g., by varying a duty cycle of light source 40) based the type of energy source providing energy to imaging device 12 and/or stored energy level within storage device 60.

FIG. 3 is a flow diagram illustrating an embodiment of an imaging device power management method in accordance with the present invention. The method begins at block 100, where ASIC 22 controls movement of scanning module 30 to a scanning position. At block 102, ASIC 22 determines a stored power level of storage device 60. At decisional block 104, a determination is made whether the stored energy level of storage device 60 exceeds a predetermined threshold. If the stored energy level of storage device 60 does not exceed a predetermined threshold, the method proceeds to block 102, where ASIC 22 continues monitoring the stored energy level of storage device 60. If the stored energy level of storage device 60 exceeds a predetermined threshold, the method proceeds to block 106, where ASIC 22 turns on light source 40 of scanning module 30. At block 108, ASIC 22 performs, or otherwise causes scanning module 30 to perform, a scanning operation. For example, as described above, imaging device 12 may be configured to move scanning module 30 relative to a stationary object, or move the object relative to a stationary scanning module 30. At block 110, scanning module 30 generates image data corresponding to the scanned object.

At block 112, ASIC 22 monitors a stored energy level of storage device 60. At decisional block 114, a determination is made whether the energy storage level within storage device 60 has decreased or fallen below a predetermined threshold. If the stored energy level within the storage device 60 has not decreased or fallen below a predetermined threshold, the method proceeds to decisional block 116, where a determination is made whether the scanning operation is complete. If the scanning operation is not yet complete, the method proceeds to block 108, where the scanning operation continues. If the scanning operation is complete, the method ends.

If at decisional block 114 it is determined that the energy level stored within storage device 60 has decreased or fallen below a predetermined threshold, the method proceeds to block 118, where ASIC 22 suspends movement of scanning module 30 and turns off light source 40. At block 120, ASIC 22 pauses the scanning operation to enable recharging of storage device 60. The method then proceeds to block 102, where ASIC 22 monitors or otherwise determines the energy level stored by storage device 60.

Thus, embodiments of the present invention enable operation of imaging device 12 at a variable duty cycle based on a source of energy supplying power to the imaging device. Thus, for example, when energy is being supplied to imaging device via a data interface bus, the duty cycle of scanning module 30 is variably controlled to facilitate efficient operation of imaging device 12 and, if power is available from another energy source capable of providing a greater energy level than the data interface bus, the duty cycle is variably controlled to reduce the time necessary for completing the scanning operation.

What is claimed is:

1. An imaging device power management system, comprising:
a control circuit adapted to vary a duty cycle of a scanning module of an imaging device during a scanning operation performed by the scanning module based on a source of energy coupled to the imaging device for operating the scanning module.

2. The system of claim 1, the source of energy comprising a data interface bus.

3. The system of claim 1, further comprising a storage device adapted to store energy received from a data interface bus.

4. The system of claim 3, the control circuit adapted to monitor the energy level of the storage device.

5. The system of claim 3, the control circuit adapted to turn off a light source of the scanning module in response to a predetermined decrease in the energy level of the storage device.

6. The system of claim 3, the control circuit adapted to turn on a light source of the scanning module in response to the energy level of the storage device exceeding a predetermined threshold.

7. The system of claim 1, the control circuit adapted to suspend movement of the scanning module during the scanning operation while a light source of the scanning module is off.

8. The system of claim 1, the control circuit adapted to pause the scanning operation to enable recharging of a storage device, the storage device providing energy for operating the scanning module.

9. The system of claim 1, the control circuit adapted to operate the scanning module at a duty cycle of less than one hundred percent (100%) when operating the scanning module from a data interface bus source of energy.

10. The system of claim 1, the control circuit adapted to vary a duty cycle of a light source of the scanning module during the scanning operation based on the source of energy coupled to the imaging device for operating the scanning module.

11. The system of claim 1, the scanning module adapted to be operated using any of a plurality of different types of energy sources.

12. The system of claim 1, the imaging device comprising a scanner.

13. The system of claim 1, the imaging device comprising a facsimile machine.

14. The system of claim 1, the imaging device comprising a copier.

15. An imaging device power management system, comprising:
means disposed in an imaging device for scanning an object; and
means for varying a duty cycle of the scanning means during a scanning operation performed by the scanning means based on a source of energy coupled to the imaging device for operating the scanning means.

16. The system of claim 15, further comprising means for storing energy received from a data interface bus.

17. The system of claim 15, wherein the means for varying a duty cycle comprises means for operating the scanning means at a duty cycle of less than one hundred percent (100%) when operating the scanning means from a data interface bus energy source.

18. The system of claim 15, further comprising means for varying a duty cycle of a light source of the scanning means based on the source of energy coupled to the imaging device for operating the scanning means.

19. An imaging device power management method, comprising:
varying a duty cycle of a scanning module of an imaging device during a scanning operation performed by the scanning module based on the type of energy source coupled to the imaging device for performing the scanning operation.

20. The method of claim 19, further comprising varying a duty cycle of a light source of the scanning module based on the type of energy source coupled to the imaging device for performing the scanning operation.

21. The method of claim 19, further comprising storing energy for operating the scanning module when the energy for operating the scanning module is provided by a data interface bus.

22. The method of claim 21, further comprising monitoring the level of the stored energy.

23. The method of claim 19, further comprising operating the scanning module at a duty cycle of less than one hundred percent (100%) when operating the scanning module using energy supplied from a data interface bus.

24. The method of claim 19, further comprising pausing the scanning operation to enable recharging of a storage device, the storage device providing energy for operating the scanning module.

25. An imaging device power management system, comprising:
a light source adapted to illuminate an object during a scanning operation;
a storage device adapted to store energy received from a data interface bus; and
a control circuit adapted to vary a duty cycle of the light source during the scanning operation corresponding to the energy stored in the storage device.

26. The system of claim 25, the control circuit adapted to monitor a level of the energy stored in the storage device.

27. The system of claim 25, the control circuit adapted to pause the scanning operation to enable recharging of the storage device.

28. The system of claim 25, the control circuit adapted to turn off the light source in response to a predetermined decrease an energy level of the storage device.

29. The system of claim 25, the control circuit adapted to turn on the light source in response to an energy level of the storage device exceeding a predetermined threshold.
